(19) United States
(12) Patent Application Publication
(10) Pub. No.: US 2020/0180181 A1
(43) Pub. Date: Jun. 11, 2020

(54) SYSTEMS AND METHODS FOR CHAIN DISPENSING AND CUTTING

(71) Applicant: U.S. Tsubaki Holdings, Inc., Wheeling, IL (US)

(72) Inventors: Paul Stawasz, Wheeling, IL (US); Robert Hogan, Wheeling, IL (US); Charles Monty, Wheeling, IL (US)

(21) Appl. No.: 16/711,031

(22) Filed: Dec. 11, 2019

Related U.S. Application Data
(60) Provisional application No. 62/778,083, filed on Dec. 11, 2018.

(51) Int. Cl. B26D 7/06; G05B 15/02

(52) U.S. Cl. CPC B26D 7/06; G05B 15/02

(57) ABSTRACT

A present application relates to a chain management system that includes a chain dispensing unit and/or a chain cutting device or table configured to conveniently store reels of roller chain and/or separate the reels into customized strand lengths while significantly reducing the amount of handling and manual disassembly tooling required. The chain dispensing unit includes a rotatable station carousel capable of holding a plurality of reels, which allows reels of neatly stored roller chain to be stored, moved and/or dispensed using a single control point. Reels of the chain dispensing unit can be cycled to a position from which the user can dispense the roller chain to the chain cutting table where the roller chain can be disassembled into customized strand lengths, and then the unused remainder of the roller chain can be returned to the reel.

### CROSS REFERENCE TO RELATED APPLICATIONS

This application is a Non-Provisional Patent Application of U.S. Provisional Patent Application No. 62/778,083 entitled “Systems and Methods for Chain Dispensing and Cutting” filed Dec. 11, 2018, which is herein incorporated by reference in its entirety.

### BACKGROUND

Industrial roller chain is used for a variety of applications including power transmission, food processing, bulk conveying, and product packaging, as but a few non-limiting examples. Industrial roller chain is typically supplied in either a standard boxed 10-foot strand, or in a strand length that is customized for a particular user's drive chain and/or application. For consumers of large volumes of roller chain, providing the roller chain on reels can be an effective means of bulk supply. However, reeled chain can present challenges for proper storage, handling, utilization and/or sectioning of the chain to a desired length for the selected application. Accordingly, the need exists for an improved system for storing, dispensing and sectioning of reeled roller chain that overcomes the challenges posed by conventional systems.

### SUMMARY

Certain embodiments of the present technology relate to a chain management system that includes a chain dispensing unit and/or a chain cutting device configured to conveniently store reels of roller chain and/or separate the reels into customized strand lengths while significantly reducing the amount of handling and manual disassembly work required. The chain dispensing unit includes a rotatable station carousel capable of holding a plurality of reels, which allows reels of roller chain to be stored, moved and/or dispensed using a single control point.

### BRIEF DESCRIPTION OF SEVERAL VIEWS OF THE DRAWINGS

FIG. 1 illustrates a chain dispenser unit, according to certain inventive techniques.

FIG. 2 illustrates a chain cutter device, according to certain inventive techniques.

FIG. 3 illustrates a combined chain management system that includes the chain dispenser unit of FIG. 1 and the chain cutter device of FIG. 2, according to certain inventive techniques.

FIG. 4 illustrates a chain dispenser unit without reels, chain or a drip pan, according to certain inventive techniques.

FIG. 5 illustrates a chain dispenser unit including reels on alternating reel stations, without chain or a drip pan, according to certain inventive techniques.

FIG. 6 illustrates a view of a chain cutter device facing a chain dispenser unit, according to certain inventive techniques.

FIG. 7 illustrates an alternate view of a combined chain management system that includes the chain dispenser unit of FIG. 1 and the chain cutter device of FIG. 2, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

In disclosed examples, systems and methods provide solutions to the challenges associated with management of large volume industrial roller chain reels. As disclosed herein, the present invention is a chain management system that includes a chain dispensing unit and/or a chain cutting device or table configured to conveniently store reels of roller chain and/or separate the reels into customized strand lengths while significantly reducing the amount of handling and manual disassembly tooling required.

The chain dispensing unit includes a rotatable station carousel capable of holding a plurality of reels, which allows reels of neatly stored roller chain to be stored, moved and/or dispensed using a single control point. The chain dispensing unit can be moved to a location from which the user can dispense the roller chain to the chain cutting table where the roller chain can be disassembled into customized strand lengths, and then the unused remainder of the roller chain can be returned to the reel.

The disclosed system provides convenient storage in a variety of conditions, such that the roller chain is kept away from dirt and debris that can deteriorate the performance of the roller chain, unnecessary handling and maneuvering of heavy chain reels (i.e. from racks to bench tops, and back again) is avoided, and the need for loose, manual disassembly tooling such as chain vises, punches, and hammers is limited or eliminated.

In disclosed examples, a chain management system includes a chain dispensing unit having a rotatable station carousel configured to hold a plurality of reels on opposing reel stations, the chain dispensing unit configured to store, move or dispense chain from each reel by using a single control. Also included in a chain cutting device configured to disassemble chain from the reels to form customized strand lengths.

In some examples, the station carousel further comprises a plurality of reel stations extending radially from a central axis about which the station carousel rotates. In examples, each reel station comprises a plurality of shafts to support the reels, each shaft attached to a respective reel station via one or more self-leveling shaft holders. In examples, the plurality of reel stations includes three or more reel stations. In examples, each reel station is configured to support two or more reels.

In some examples, the chain management system also includes a drive mechanism to rotate the station carousel. In examples, the drive mechanism is a manually controlled drive mechanism. In examples, the drive mechanism is a motorized drive mechanism. In examples, the drive mechanism is controlled by a user input via a computing platform.

In some examples, the chain cutting device comprises a hydraulically powered tool. In examples, the chain dispensing unit also includes a frame assembly to support the station carousel, the frame assembly comprising one or more adjustable levelers to interface with an underlying surface. IN examples, the frame assembly comprises one or more adjustable cross-bars to allow loading of reels by one of a pallet jack or a forklift. In examples, the chain dispensing unit further comprising a drip pan to catch debris or oil during a chain disassembly operation.

In some examples, the chain cutting device comprises a support frame comprising one or more lockable casters to provide for transportation or positioning of the chain cutting device. In examples, the chain cutting device further comprises a catch pan to catch loose chain components during a chain disassembly operation.

In some disclosed examples, a chain management system includes a chain dispensing unit including a rotatable station carousel configured to hold a plurality of reels on opposing reel stations, the chain dispensing unit configured to store, move or dispense chain from each reel by using a single control. Also included is a chain cutting device to disassemble the chain into customized strand lengths, the chain cutting device comprising an interlock to prevent unintentional cutting or disassembly of the chain.

In some examples, the interlock comprises an electronic or mechanical interlock mechanism. In examples, the chain cutting device further comprises a reel hanger to support one or more reels, wherein the reel hanger is removably mounted to a support frame of the chain cutting device.

In some examples, the chain cutting device further comprises a cutting tool, the cutting tool enclosed by one or more panels mounted to the chain cutting device via one or more friction hinges configured to prevent unintentional access to the cutting tool.

In examples, the chain cutting device further comprises a removable catch pan to catch debris or oil during a chain disassembly operation.

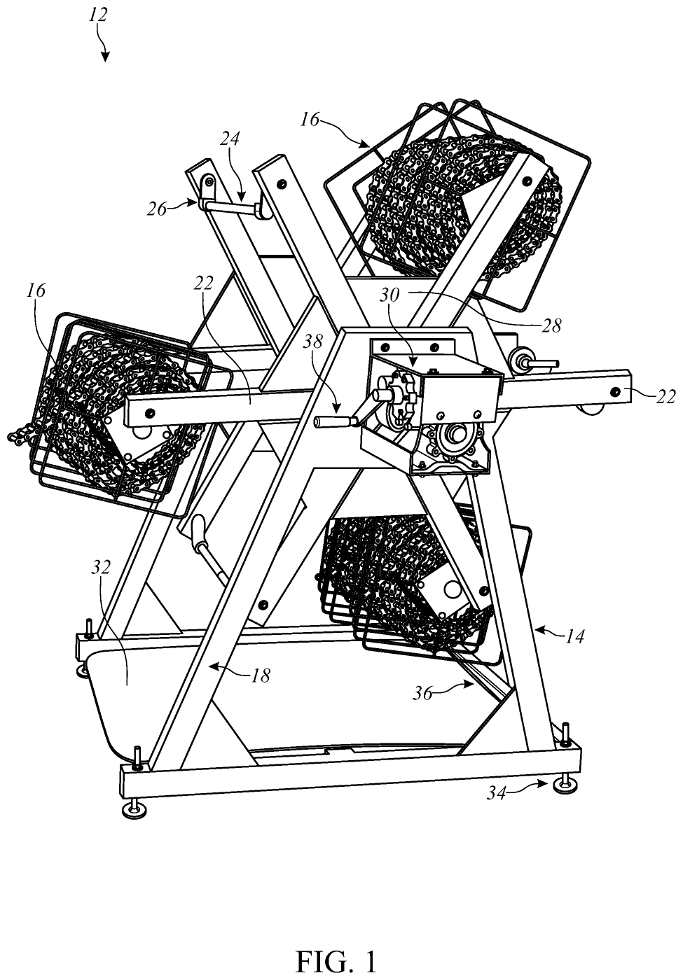

One example of the present system, as illustrated in FIG. 1, includes a chain dispenser unit 12, which provides a frame assembly 14 that is capable of storing a plurality of reels 16 (e.g., spools, cylinders, coils, spindles, rolls, etc.) of roller chain (e.g., twelve (12)) in a convenient and organized manner The frame assembly 14 is designed for maximum stability during storage and/or dispensing of the chain, regardless of load pattern. For example, a plurality of supports 18 are arranged to support movement of a station carousel 28 such that, even as the reels 16 rotate about a central axis, the unit 12 remains stable on an underlying surface (i.e. ground, a shop floor, etc.).

As shown in FIG. 1, one or more of the reel stations 22 may not be in use, yet the supports 18 maintain stability and allow a user to cycle through the reels 16. Each reel station 22 includes a shaft 24 to support one or more reels 16, the shaft 24 being compatible with a variety of standard industry reels. In some examples, each shaft 24 is attached to a respective reel station 22 of the station carousel 28 by self-leveling shaft holders 26. The station carousel 28 is driven by a drive mechanism 30 (e.g., a motor and/or hand operable mechanism 38) that is easily controlled by an operator (i.e. via a controller and/or physical movement of a lever and gear). In some examples, movement of the station carousel 28 is controlled by a computing platform (e.g., a laptop, a smartphone, a remote control, etc.) with a user interface operable to regulate rotation of the station carousel 28 in response to a user input.

The chain dispenser unit 12 includes additional or alternative features that provide advantages over conventional systems. For example, the unit 12 includes anti-backlash features configured to hold the reel stations 22 firmly in place after cycling to a desired position to facilitate dispensing and/or cutting. A drip pan 32 is situated beneath the reels 16 to catch residual oil and/or debris that may fall from stored chain reels to protect the underlying surface and maintain an obstacle and slip-free surface.

Bottom cross-bars 36 of the frame assembly 14 are positioned to allow loading reels 16 to be engaged by pallet jacks, forklifts, and similar machines (e.g., the drip pan can be repositioned or removed to accommodate such a machine). For example, specialized cradles, combined with the solid frame 14 construction, allow free access by these lift-assist mechanisms to load the reels 16 onto a station carousel 28 without manual lifting.

As illustrated in FIG. 1, the chain dispenser unit 12 provides six reel stations 22, and has the capacity to store a plurality of reels 16 (as shown, six (6) reels, with two such reels 16 on three shafts 24), which offers a substantial improvement in capacity over conventional storage and distribution means. In some examples, the chain dispenser unit 12 can provide fewer than six reel stations 22, or more than six reel stations 22, depending on the application, environment, type of chain in use, etc.

In some examples, one or more features of the chain dispensing unit 12 (e.g., the frame assembly 14, the station carousel 28, reel stations 22, etc.) are treated to enhance corrosion resistance (e.g., the features can be painted, subjected to a powder-coated treatment, chemical bonding, electro-plating, etc.). Additionally or alternatively, one or more of the chain dispenser unit's 12 structural members are fitted with end-caps to prevent corrosion on the uncoated internal surfaces.

Additionally or alternatively, the frame assembly 14 can use adjustable levelers 34 on the interface with the underlying surface to provide stability on uneven flooring when the system is in use. In some examples, the design of the unit 12 allows for optional provision of casters (e.g., such as lockable casters, in addition to or as a substitution to adjustable levelers 34) on the chain dispenser unit 12 to permit movement of the unit 12 while retaining full stability.

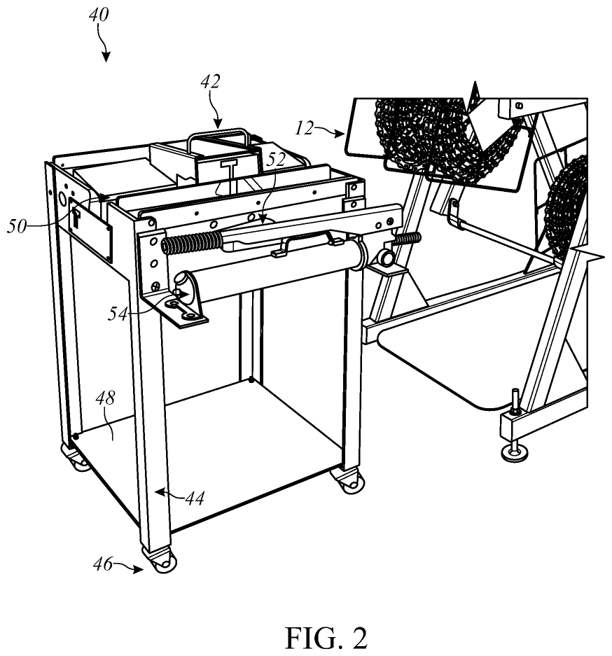

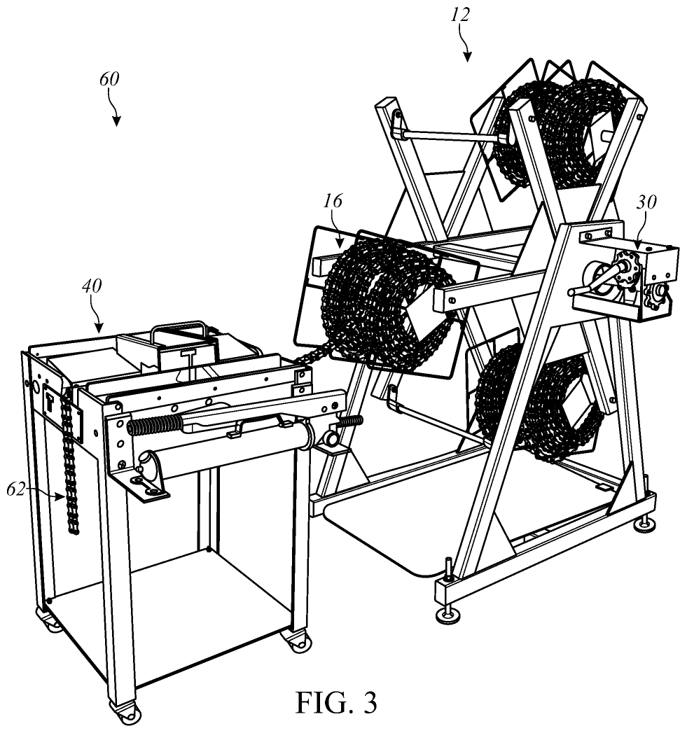

FIG. 2 illustrates a chain cutting device 40 capable of converting reels of roller chain 16 into customized lengths by an operator and/or machine without the use of manual disassembly tooling such as hammers, punches, chain vises, etc. Disassembly tooling 42 employed by the chain cutting device 40 is designed to be easily interchangeable for various sizes and styles of chain by using quick disconnect retention pins to securely retain tooling sets. For example, the device is capable of cutting size 120 chain. The chain cutting device 40 is arranged on a sturdy frame 44 with lockable casters 46 at a base 48 of the chain cutting device 40 to allow for standalone usage, and/or usage in combination with the chain dispenser unit 12 (see, e.g., FIG. 3).

The chain cutting device 40 includes additional or alternative features that provide advantages over conventional systems. For example, the lockable casters 46 are designed for heavy loads and use in industrial environments, with materials and features to ensure desired operability over long periods of continued use. The lockable caster 46 further allow transport of the chain cutting device 40 to a point of use, and/or positioning of the chain cutting device 40 at the output of the chain dispenser unit 12. In some examples, a catch pan 52 can be located underneath the tooling section of a chain breaker 50 associated with the chain cutting device 40 (e.g., mounted beneath the chain breaker on a removable shelf, within an interior of the chain cutting device 40, mounted on base 48, etc.) to catch loose components generated by the disassembly of chain. The catch pan 52 can be a single unit (e.g., formed of a single piece of metal or other material) or a combination of units to allow for placement on the chain cutting device 40. Further, the catch pan 52 can be completely or partially removed from the chain cutting device 40 (e.g., to discard loose components, to facilitate maintenance or cleaning, etc.).

In some examples, features of the chain cutting device 40 (e.g., the frame 44, the base 48) are treated to enhance corrosion resistance (e.g., the features can be painted, subjected to a powder-coated treatment, chemical bonding, electro-plating, etc.). Additionally or alternatively, one or more of the chain cutting device's 40 structural members are fitted with end-caps to prevent corrosion on uncoated internal surfaces.

In some examples, the cutting tool 42 employs a mechanical device 54 to disassemble chain. For example, the mechanical device 54 may include a hydraulically powered tool, which is actuated via either a hand pump and/or an electric motor driven pump. In some examples, an interlock is included with the chain cutting device 40 to prevent unintentional cutting (e.g., added to the frame 44 and/or incorporated within the mechanical device 54). Incorporating the interlock can prevent the use of electric and/or powered cutting mechanisms, such as when one or more interlock guards are open or disengaged. For example, the interlock may be configured as an electronic interlock (e.g., one or more of a solid-state switch, a biased contactor, a relay, a circuit breaker, etc.), or may be configured as a mechanical interlock (e.g., a spring-loaded bolt, a unidirectional ratchet, etc.), which requires activation to allow cutting.

Additionally or alternatively, the chain cutting device 40 and/or the cutting tool 42 employs one or more panels or covers to enclose a cutting operation, for example. Such panels may be hinged to allow access to features of the cutting tool 42 (e.g., for setting up a chain cutting operation, maintenance or cleaning, etc.). In some examples, the hinges may control opening and/or closing of the panels, by use of a friction hinge to prevent the panel from unintentionally opening (e.g., in response to a strike from a removed chain component) and/or closing (e.g., falling rapidly once let go of). In examples, the panels may be locked into position (open, closed, or at angles between) by one or more mechanisms.

In some examples, the chain cutting device 40 is configured to accept one or more reels separate from the chain dispenser unit 12. This configuration allows the chain cutting device 40 to perform standalone cutting operations without the use of the chain dispenser unit 12. For instance, a reel hanger or other suitable support may be mounted to the frame 44 of the chain cutting device 40, the reel hanger configured to feed wire to the cutting tool 42 (e.g., via a wire reel 16). In some examples, the reel hanger is removably mounted directly to the frame 44. In other examples, the reel hanger is a convertible mechanism that can be stowed within the frame 44 when not being used. Additionally or alternatively, the reel hanger is a standalone device, which can be aligned with the chain cutting device 40 (e.g., via one or more physical or virtual guides) to ensure the wire is properly fed into the cutting tool. 42.

Illustrated in FIG. 3 is a combined chain management system 60 that includes both the chain dispenser unit 12 and the chain cutting device 40. As disclosed herein, the chain management system 60 provides a convenient, organized manner for storing multiple reels 16 of chain 62 in a centralized location. The combined chain management system 60 is configured to cycle through selecting of stored reels 16, dispensing of lengths of chain from reels 16 at an accessible position, disassembling of the bulk chain into user customizable lengths of chain 62, and removing the lengths from the system 60 for use.

Advantageously, the user can remove the disassembled chain 62 and return the unused portion to the reel 16. Further, a second selection can be presented by use of convenient control of the drive mechanism 30.

Additionally or alternatively, one or more features can be used to facilitate cooperation between the chain dispenser unit 12 and the chain cutting device 40. For instance, the drive mechanism 30 may communicate with the cutting tool 42 to ensure the proper amount of chain is removed from the selected reel 16, ensuring proper length of the disassembled chain 62. For example, one or more measurement devices (not shown) may be included on one or both of the chain dispenser unit 12 or chain cutting device 40 to coordinate chain 62 lengths. Further, such information can be transmitted to a computing platform for analysis in maintaining stock of chain, generating invoices, labeling/marking/assigning disassembled chain 62 for a particular application, and generating maintenance alerts or requests, as but a few non-limiting examples.

In some examples, the chain dispenser unit 12 and chain cutting device 40 can be physically linked, such as by a stabilization mount or other structural device. Once in a common location, a physical link can ensure proper alignment between the chain dispenser unit 12 and the chain cutting device 40 for dispensing and cutting operations. Such a link may be attached to one of the chain dispenser unit 12 or the chain cutting device 40, to ensure the link is readily accessible on the structure, and/or the link properly connects to attachment points on both the chain dispenser unit 12 and the chain cutting device 40.

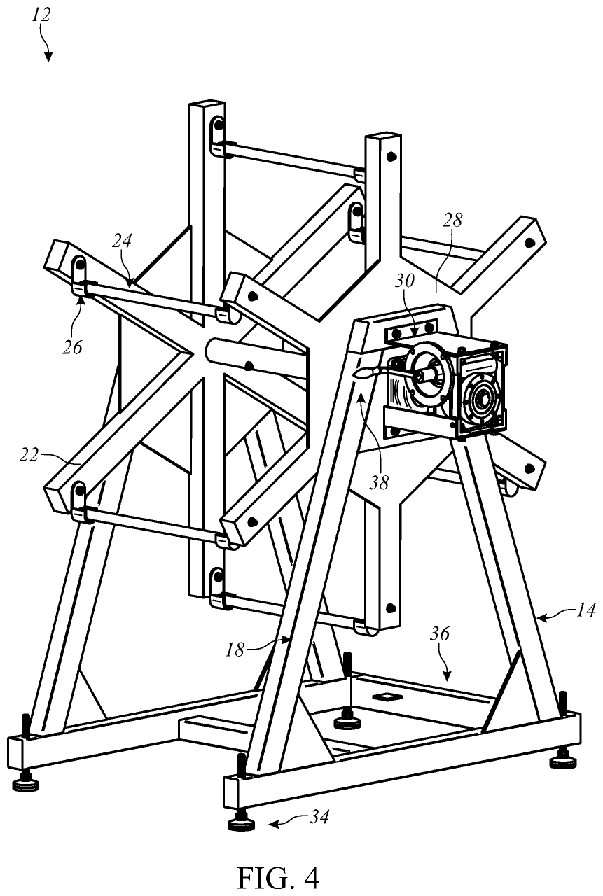

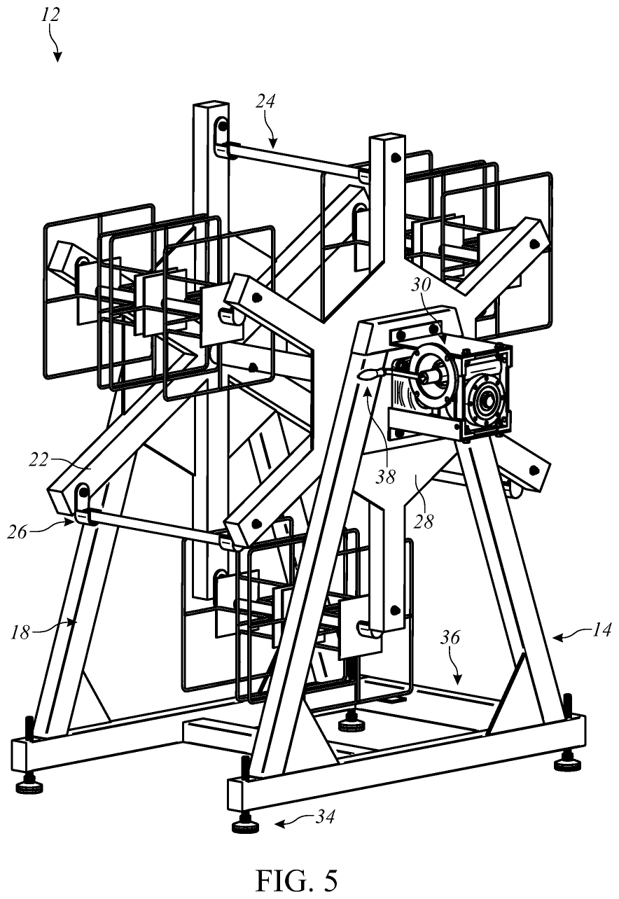

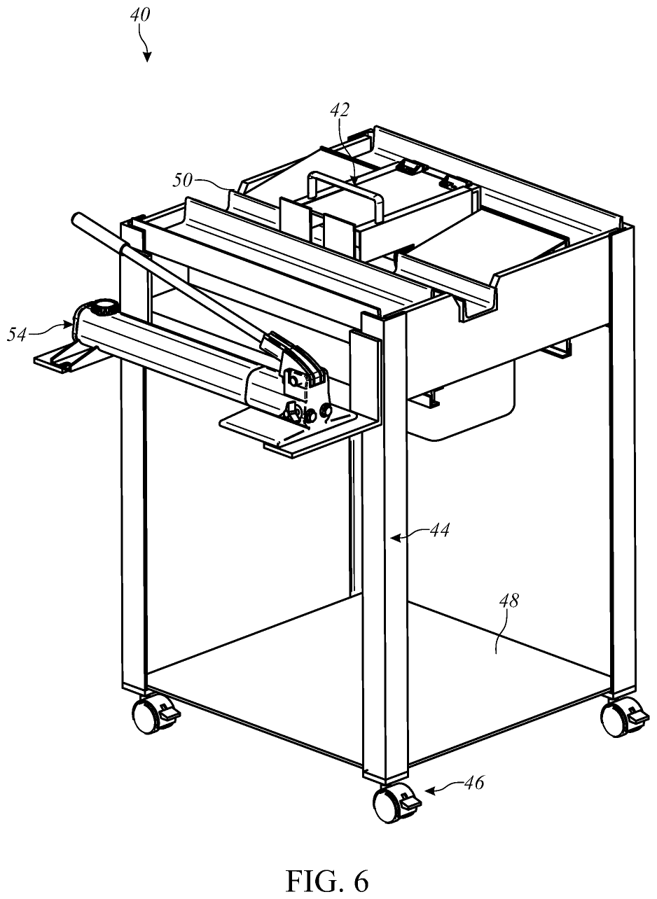

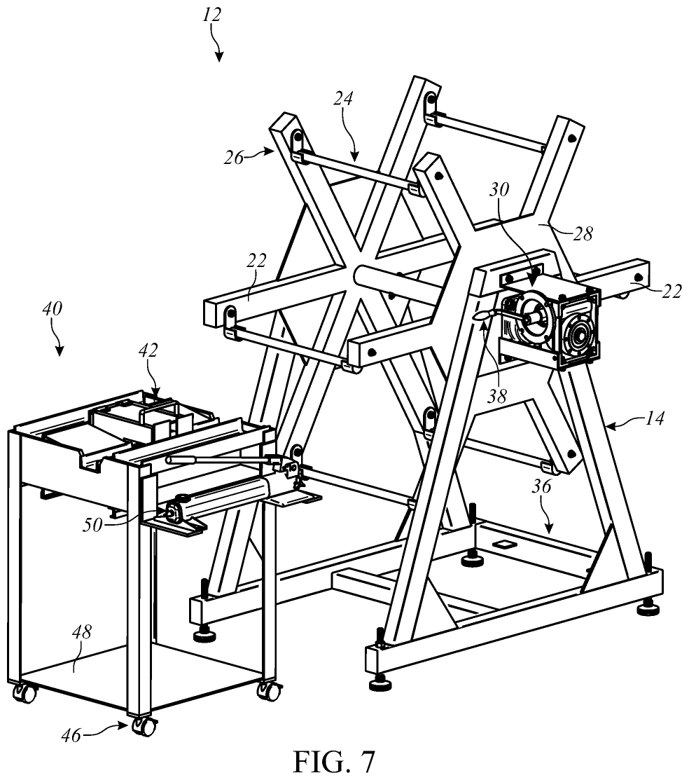

FIG. 4 illustrates a chain dispenser unit, such as chain dispenser unit 12 of FIG. 1, without reels, chain or a drip pan. FIG. 5 also illustrates a chain dispenser unit, however several reels are shown on alternating reel positions. FIG. 6 illustrates a view of a chain cutter device facing a chain dispenser unit, such as where chain is fed from the chain dispenser unit 12. FIG. 7 illustrates an alternate view of a combined chain management system that includes a chain dispenser unit and a chain cutter device. As illustrated, the system of FIG. 7 is shown without reels, chain or a drip pan.

The disclosed embodiments are not limited to the specific arrangement or components discussed with respect to those embodiments. It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A chain management system comprises:
a chain dispensing unit including a rotatable station carousel configured to hold a plurality of reels on opposing reel stations, the chain dispensing unit configured to store, move or dispense chain from each reel by using a single control; and
a chain cutting device configured to disassemble or cut chain from the reels to form customized strand lengths.

2. The chain management system of claim 1, wherein the station carousel further comprises a plurality of reel stations extending radially from a central axis about which the station carousel rotates.

3. The chain management system of claim 2, wherein each reel station comprises a plurality of shafts to support the reels, each shaft attached to a respective reel station via one or more self-leveling shaft holders.

4. The chain management system of claim 2, wherein the plurality of reel stations includes three or more reel stations.

5. The chain management system of claim 2, wherein each reel station is configured to support two or more reels.

6. The chain management system of claim 1, further comprising a drive mechanism to rotate the station carousel.

7. The chain management system of claim 6, wherein the drive mechanism is a manually controlled drive mechanism.

8. The chain management system of claim 6, wherein the drive mechanism is a motorized drive mechanism.

9. The chain management system of claim 8, wherein the drive mechanism is controlled by a user input via a computing platform.

10. The chain management system of claim 1, wherein the chain cutting device comprises a hydraulically powered tool.

11. The chain management system of claim 1, wherein the chain dispensing unit further comprising a frame assembly to support the station carousel, the frame assembly comprising one or more adjustable levelers to interface with an underlying surface.

12. The chain management system of claim 11, wherein the frame assembly comprises one or more adjustable cross-bars to allow loading of reels by one of a pallet jack or a forklift.

13. The chain management system of claim 11, wherein the chain dispensing unit further comprising a drip pan to catch debris or oil during a chain disassembly operation.

14. The chain management system of claim 1, wherein the chain cutting device comprises a support frame comprising one or more lockable casters to provide for transportation or positioning of the chain cutting device.

15. The chain management system of claim 14, wherein the chain cutting device further comprises a catch pan to catch loose chain components during a chain disassembly operation.

16. A chain management system comprises:
a chain dispensing unit including a rotatable station carousel configured to hold a plurality of reels on opposing reel stations, the chain dispensing unit configured to store, move or dispense chain from each reel by using a single control; and
a chain cutting device configured to disassemble the chain into customized strand lengths, the chain cutting device comprising an interlock to prevent unintentional cutting or disassembly of the chain.

17. The chain management system of claim 16, wherein the interlock comprises an electronic or mechanical interlock mechanism.

18. The chain management system of claim 16, wherein the chain cutting device further comprises a reel hanger to support one or more reels, wherein the reel hanger is removably mounted to a support frame of the chain cutting device.

19. The chain management system of claim 16, wherein the chain cutting device further comprises a cutting tool, the cutting tool enclosed by one or more panels mounted to the chain cutting device via one or more friction hinges configured to prevent unintentional access to the cutting tool.

20. The chain management system of claim 16, wherein the chain cutting device further comprises a removable catch pan to catch debris or oil during a chain disassembly operation.
